(19) United States
(12) Patent Application Publication
(10) Pub. No.: US 2018/0320731 A1
(43) Pub. Date: Nov. 8, 2018

(54) Length-Adjustable Connecting Rod

(71) Applicant: AVL LIST GMBH, GRAZ (AT)

(72) Inventors: Helmut Melde-Tuczai, Graz (AT); Siegfried Hartwig, Graz (AT)

(73) Assignee: AVL LIST GMBH, GRAZ (AT)

(21) Appl. No.: 15/771,283

(22) PCT Filed: Nov. 7, 2016
(86) PCT No.: PCT/AT2016/060103

§ 371 Date: May 4, 2018

(30) Foreign Application Priority Data
Nov. 5, 2015 (AT) A 50942/2015

(51) Int. Cl. F16C 7/06; F02B 75/04; F15B 15/14

(52) U.S. Cl. CPC F16C 7/06; F15B 15/14; F02B 75/045

(57) ABSTRACT

The invention relates to a length-adjustable connecting rod (1) for a reciprocating piston machine, comprising at least one first rod part (2) with a small connecting rod eye (3) and at least one second rod part (4) with a large connecting rod eye (5), both rod parts (2, 4) being movable in relation to each other or inside each other in a telescoping manner. The second rod part (4) comprises a guide cylinder (8) and the first rod part (2) is securely connected to a piston element (7) that can move longitudinally in the guide cylinder (8), a first high-pressure chamber (10) being mounted on a first side of the piston element (7) between the second rod part (4) and the piston element (7), and a second high-pressure chamber (12) being mounted on a second side of the piston element (7), at least one sealing element (22, 24) being provided for sealing at least one high-pressure chamber (10, 12). The aim of the invention is to allow a wear-resistant seal between the two rod parts (2, 4) as easily, compactly and reliably as possible. To this end, the piston element (7) is non-positively connected to the first rod part (2) by means of an interference fit (30) in a interference-fit region (30a).

The invention relates to a length-adjustable connecting rod for a reciprocating engine, in particular an internal combustion engine, comprising at least one first rod part with a small connecting rod eye and at least one second rod part with a large connecting rod eye, which two rod parts are movable in relation to each other and/or inside each other in a telescoping manner in the direction of a longitudinal axis of the connecting rod, wherein the second rod part comprises a guide cylinder and the first rod part is fixedly connected to a piston element that can move longitudinally in the guide cylinder, wherein a first high-pressure chamber is defined on a first side of the piston element between the second rod part and the piston element, and a second high-pressure chamber is defined on a second side of the piston element, wherein each high-pressure chamber is flow-connected to at least one oil passage, and wherein at least one sealing element is provided for sealing at least one high-pressure chamber.

The publication AT 514 071 B1 discloses an internal combustion engine with a length-adjustable connecting rod with a first and a second rod part, which rod parts are movable in relation to each other and inside each other in a telescoping manner. In this case, the second rod part has a piston element designed as a stepped piston, which is guided in a guide cylinder formed by the first rod part. With mutually opposite end faces, the piston element adjoins a high-pressure chamber in each case, which is arranged between the first and the second rod part. For refilling and emptying the high-pressure chamber with oil and thus for length adjustment of the connecting rod, a control valve is provided in the connecting rod. For sealing the high-pressure chambers between the piston element and the guide cylinder, and between the second rod part and a clamping sleeve firmly connected to the first rod part, a sealing element such as an O-ring is arranged in each case. In this case, however, axial crushing can occur and, consequently, a strong wear of the sealing elements due to the axial movement along the inner surfaces of the guide cylinder or the clamping sleeve.

It is the object of the invention to avoid the disadvantages mentioned and to enable a low-wear seal between the two rod parts which is as simple, compact and reliable as possible.

This is achieved according to the invention in that the piston element is non-positively connected to the first rod part via an interference fit in a press-fit region.

The press-fit region of the piston element is preferably formed by an inner jacket surface of an annular end region of the piston element facing the small connecting-rod eye and the press-fit region of the first rod part by an outer jacket surface of a shoulder region of the first rod part facing away from the small connecting-rod eye. The inner diameter of the inner jacket surface of the annular end region is made smaller—before the assembly—at least in the press-fit region than the outer diameter of the outer jacket surface of the shoulder region. Due to this interference fit, a non-positive connection, which is not operationally releasable, occurs between the piston element and the first rod part after assembly. Due to the interference fit, a radial shoulder can be dispensed with, via which the piston element and the first rod part—to relieve the second sealing element—support each other. Such a radial shoulder would have the disadvantage that a relatively large amount of space in the radial direction would be necessary, which would significantly increase the size and weight of the connecting rod. In contrast, the solution according to the invention makes it possible to keep the size of the connecting rod and its weight as small as possible.

In one variant of the invention, at least one second sealing element is then arranged in a force-free manner adjacent to the press-fit region between the first rod part and the piston element in the direction of the longitudinal axis for sealing the second high-pressure space between the first rod part and the second rod part or a clamping sleeve firmly connected to the second rod part. In order to additionally exclude axial crushing of the second sealing element, it is advantageous if the second sealing element has a defined play relative to the piston element and/or the second rod part in the direction of the longitudinal axis.

In a preferred embodiment of the invention it is provided that the piston element has a first piston part and a second piston part, wherein the first piston part is adjacent to the first high-pressure chamber and the second piston part to the second high-pressure chamber, wherein preferably the second piston part forms the press-fit region of the piston element.

The interference fit is chosen so that the mass force of the second piston element can be transferred to the first rod part.

An advantageous embodiment of the invention provides that the first piston part is screwed to the first rod part, wherein preferably the first piston part has a blind bore with an internal thread, which is screwed to an external thread of the first rod part. The first piston part adjoining the first high-pressure chamber is thus formed similar to a cap nut and screwed onto the first rod part from a side facing away from the small connecting rod eye.

Due to the fact that the first piston part, similar to a cap nut, has a blind bore with an internal thread, internal leakage via the thread of the screw connection can be avoided. Alternatively, in principle, a design with a conventional nut is also possible. In this case, additional sealing elements are then provided due to the mentioned leakage.

Conveniently, the first piston part and the second piston part are interconnected by annular contact surfaces in the direction of the longitudinal axis, which are preferably arranged normally on the longitudinal axis. It is particularly advantageous if for sealing the first high-pressure chamber between the piston element and guide cylinder adjacent to at least one contact surface at least one first sealing element is arranged without force in the direction of the longitudinal axis between the first piston part and the second piston part. In this case, the first sealing element preferably has a defined play in the direction of the longitudinal axis relative to the first piston part and/or the second piston part. As a result, an axial crushing of the first sealing element is reliably avoided.

During assembly, the second piston part is pushed with its press-fit region by tightly screwing the first piston part on the first rod part over the press-fit region of the first rod part. As a result of the pretensioning force of the screw connection formed by the internal thread of the first piston part and the external thread of the first rod part, the resistance can be overcome by the interference fit with relatively little effort.

The invention will be explained below in more detail with reference to the non-limiting exemplary embodiment illustrated in the figures, wherein:

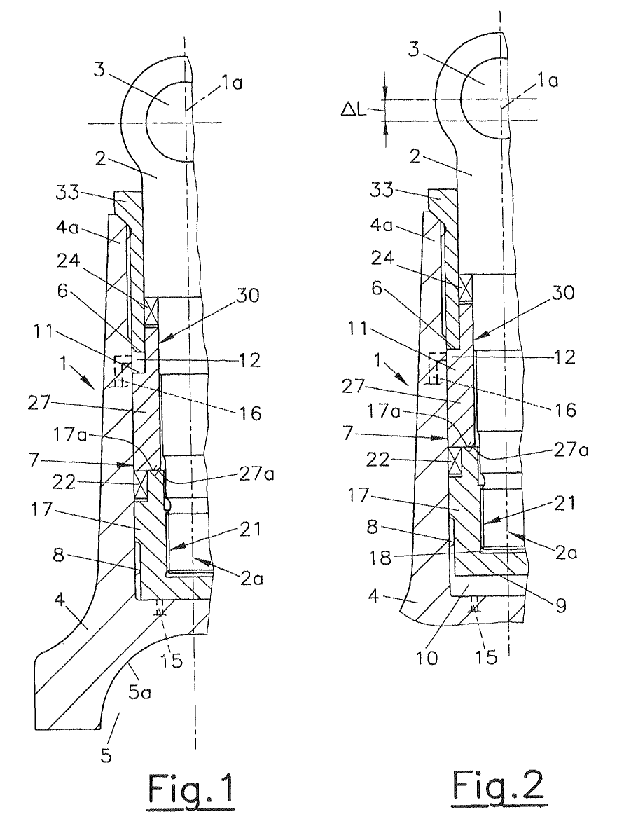

FIG. 1 shows a connecting rod according to the invention in a longitudinal section in a first switching position;

FIG. 2 shows this connecting rod in a longitudinal section in a second first switching position, and

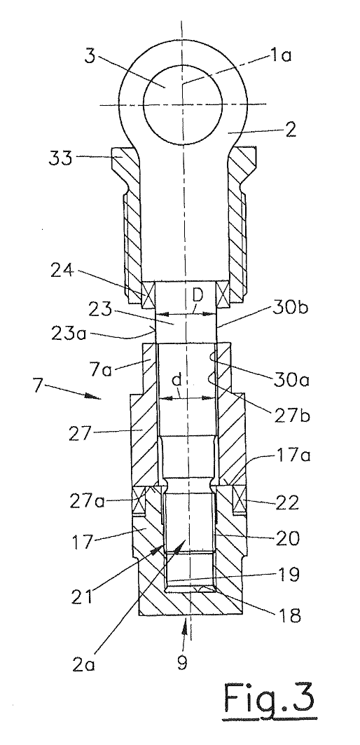

FIG. 3 shows an assembly step of this connecting rod in a longitudinal section.

In FIGS. 1 and 2, only one half side of the connecting rod 1 is shown in each case.

FIG. 1 and FIG. 2 each show a two-part connecting rod 1 of a reciprocating engine, in particular an internal combustion engine with an upper first rod part 2 with the small connecting rod eye 3 for connection to a piston (not shown) and a lower second rod part 4 with the large connecting rod eye 5 forming a connecting rod bearing 5a for connection to a crankshaft (not shown). The first rod part 2 is adjustable relative to the second rod part 4 between an extended position and a retracted position by an adjusting range limited by an end stop 6 in the direction of the longitudinal axis 1a of the connecting rod 1. In the upper first rod part 2, a substantially cylindrical piston element 7 is attached.

The first rod part 2 and the second rod part 4 of the connecting rod 1 are hydraulically coupled in the pressure direction and mechanically limited in their movement in the opposite direction by the end stop 6. Pressure direction here means the direction in which the force of combustion in the piston chamber acts on the piston (not shown). The hydraulic coupling is to be understood here in such a way that in each setting of the connecting rod 1 a respective hydraulic pad arranged elsewhere supports the first rod part 2 against the second rod part 4.

The piston element 7 designed as a stepped piston is displaceably guided axially (in the direction of the longitudinal axis 1a of the connecting rod 1) in a guide cylinder 8 of the lower second rod part 4 of the connecting rod 1, wherein a first high-pressure chamber 10 is defined between a first end face 9 of the piston element 7 facing the large connecting rod eye 5 and the second rod part 4 or the guide cylinder 8 in an extended position of the two rod parts 2, 4 shown in FIG. 2. Furthermore, a second high-pressure chamber 12 is defined between a second end face 11 of the piston element 7 facing the small connecting rod eye 3 and the second rod part 4 in a contracted position of the two rod parts 2, 4. In the illustrated embodiment, the second high-pressure chamber 12 is defined between the second end face 11 and a clamping sleeve 33 as part of the second rod part 4.

A stepped piston is generally understood to be a piston—in the present case a “double-acting piston”—with differently sized effective surfaces, wherein one of the effective surfaces (here: the effective surface oriented against the second high-pressure chamber 12) is formed as an annular surface and the other effective surface is formed as a circular surface. Due to the different effective surfaces, different pressure conditions can be realized.

The annular first end faces 9 and second end faces 11 form pressure application surfaces for an actuating medium, for example engine oil, which is conducted into the high-pressure chambers 10, 12 and is under pressure.

The first high-pressure chamber 10 and the second high-pressure chamber 12 are connected via oil passages 15, 16 to a control valve (not shown), which is designed for example as a simple switching valve, which selectively acts on the first 10 or second high-pressure chamber 12 with oil pressure. The pressurization of the high-pressure chambers 10, 12 with oil is not part of the invention—it can for example be carried out in a similar manner as described in AT 514 071 B1.

The volume of the first high-pressure chamber 10 is limited by a clamping sleeve 33 screwed into the shaft part 4a of the second rod part 4, which defines the maximum possible stroke of the piston element 7. Depending on the length of this clamping sleeve 33, the adjusting range ΔL of the connecting rod length of the length-adjustable connecting rod 1 can be set as required.

As clearly shown in the figures, the piston element 7 consists of a first piston part 17 and a second piston part 27. The first piston part 17 adjoins the first high-pressure chamber 10, the second piston part 27 adjoins the second high-pressure chamber 12.

The first piston part 17 is screwed to the first rod part 2 at its end 2a facing away from the small connecting rod eye 3. The first piston part 17 has a blind bore 18 with an internal thread 19, which is screwed to an external thread 20 of the first rod part 2. Internal thread 19 and external thread 20 thus form a screw connection 21 between the piston element 7 and the first rod part 2. The first piston part 17 is thus formed similar to a cap nut and screwed onto the first rod part 2 from a side facing away from the small connecting rod eye 3. As a result of the configuration of the first piston part 17 which is similar to a cap nut, an internal leakage via the thread of the screw 21 is avoided.

The first piston part 17 and the second piston part 27 of the piston element 7 are connected to each other or in contact with each other by annular contact surfaces 17a, 27a in the direction of the longitudinal axis 1a, which contact surfaces 17a, 27a are arranged in the embodiment normally on the longitudinal axis 1a of the connecting rod 1. Adjacent to the contact surface 27a of the second piston part 27, a first sealing element 22 is arranged without force between the first piston part 17 and the second piston part 27 in the direction of the longitudinal axis 1a. The axially force-free arrangement is achieved by a defined play in the direction of the longitudinal axis 1a of the first sealing element 22 relative to the first piston part 17 and/or the second piston part 27. As a result, a crushing of the first sealing element 22 in the direction of the longitudinal axis can be ruled out, which would lead to increased wear of the first sealing element 22.

The second piston part 27 of the piston element 7 is non-positively connected in its press-fit region 30a via an interference fit 30 to a corresponding press-fit region 30b of the first rod part 2. Adjacent to the press-fit regions 30a, 30b, a second sealing element 24 is arranged without force between the first rod part 2 and the second piston part 27 in the direction of the longitudinal axis 1a.

The press-fit region 30a of the piston element 7 is formed by an inner jacket surface 27b of an annular end region 7a of the piston element 7 facing the small connecting rod eye 3 and the press-fit region 30b of the first rod part 2 through an outer jacket surface 23a of a shoulder region 23 of the first rod part 2 which faces away from the small connecting rod eye 3 and adjoins the section of the first rod part 2 containing the small connecting rod eye 3. Before the assembly, the inner diameter d of the inner jacket surface 27b of the annular end region 7a is smaller than the outer diameter D of the outer jacket surface 23a of the shoulder region 23 of the first rod part 2, at least in the press-fit area 30a of the piston element 7. As a result of this interference fit 30, a non-positive connection between the piston element 7 and the first rod part 2, which is not operationally releasable, occurs after assembly. The solution according to the invention makes it possible to keep the size of the connecting rod 1 and its weight as small as possible. The interference fit 30 is selected so that the mass force of the second piston part 27 of the piston element 7 can be transmitted to the first rod part 2.

FIG. 3 shows the assembly of the piston element 7 on the first rod part 2. In this case, the second piston part 27 is pushed with its press-fit region 30a by tightly screwing the first piston part 17 on the first rod part 2 over the press-fit region 30b of the first rod part 2. As a result of the pretensioning force of the screw connection 21, the resistance caused by the interference fit 30 can be overcome relatively easily.

1. A length-adjustable connecting rod (1) for a reciprocating engine, in particular an internal combustion engine, comprising at least one first rod part (2) with a small connecting rod eye (3) and at least one second rod part (4) with a large connecting rod eye (5), which two rod parts (2, 4) are movable in relation to each other and/or inside each other in a telescoping manner in the direction of a longitudinal axis (1a) of the connecting rod (1), wherein the second rod part (4) comprises a guide cylinder (8) and the first rod part (2) is fixedly connected to a piston element (7) that can move longitudinally in the guide cylinder (8), wherein a first high-pressure chamber (10) is defined on a first side of the piston element (7) between the second rod part (4) and the piston element (7), and a second high-pressure chamber (12) is defined on a second side of the piston element (7), wherein each high-pressure chamber (10, 12) is flow-connected to at least one oil passage (15, 16), wherein at least one sealing element (22, 24) is provided for sealing at least one high-pressure chamber (10, 12), and wherein the piston element (7) is non-positively connected to the first rod part (2) via an interference fit (30) in a press-fit region (30a).

2. The connecting rod (1) according to claim 1, wherein the press-fit region (30a) of the piston element (7) is formed by an inner jacket surface (27b) of the annular end region (7a) of the piston element (7) facing the small connecting rod eye (3) and the press-fit region (30b) of the first rod part (2) is formed by an outer jacket surface (23a) of a shoulder region (23) of the first rod part (2) facing away from the small connecting rod eye (3).

3. The connecting rod (1) according to claim 1, wherein for sealing the second high-pressure chamber (12) between the first rod part (2) and the second rod part (4) or a clamping sleeve (33) fixedly connected to the second rod part (4), at least one second sealing element (24) is arranged in a force-free manner adjacent to the press-fit region (30a) of the piston element (7) in the direction of the longitudinal axis (1a) between the first rod part (2) and the piston element (7), wherein preferably the second sealing element (24) has a defined play in the direction of the longitudinal axis (1a) relative to the piston element (7) and/or the second rod part (2).

4. The connecting rod (1) according to claim 1, wherein the piston element (7) has a first piston part (17) and a second piston part (27), wherein the first piston part (17) adjoins the first high-pressure chamber (10) and the second piston part (27) adjoins the second high-pressure chamber (12).

5. The connecting rod (1) according to claim 4, wherein the second piston part (27) forms the press-fit region (30a) of the piston element (7).

6. The connecting rod (1) according to claim 4, wherein the first piston part (17) is screwed together with the first rod part (2).

7. The connecting rod (1) according to claim 4, wherein the first piston part (17) has a blind bore (18) with an internal thread (19) which is screwed to an external thread (20) of the first rod part (2).

8. The connecting rod (1) according to claim 4, wherein the first piston part (17) and the second piston part (27) are interconnected by annular contact surfaces (17a, 27a) in the direction of the longitudinal axis (1a), which are preferably arranged normally on the longitudinal axis (1 a).

9. The connecting rod (1) according to claim 8, wherein for sealing the first high-pressure chamber (10) between the piston element (7) and guide cylinder (8) at least one first sealing element (22) is arranged adjacent to at least one contact surface (17a, 27a) in the direction of the longitudinal axis (1a) without force between the first piston part (17) and the second piston part (27).

10. The connecting rod (1) according to claim 4, wherein a first sealing element (22) which is arranged for sealing the first high-pressure chamber (10) between the piston element (7) and the guide cylinder (8) has a defined play in the direction of the longitudinal axis (1a) relative to the first piston part (17) and/or the second piston part (27).
